(19) United States
(12) Patent Application Publication
(10) Pub. No.: US 2024/0293840 A1
(43) Pub. Date: Sep. 5, 2024

(54) Magnetic Fastening System For Fastening An Article To A Heating Hose, And A Corresponding Heating Hose

(71) Applicant: Robatech AG, Muri (CH)

(72) Inventors: Michael Hürlimann, Bremgarten (CH); Claudio Hofer, Hagendorn (CH)

(73) Assignee: Robatech AG, Muri (CH)

(21) Appl. No.: 18/593,085

(22) Filed: Mar. 1, 2024

(30) Foreign Application Priority Data
Mar. 3, 2023 (DE) 10 2023 105 317.5

(51) Int. Cl. B05C 11/10; H01F 7/02

(52) U.S. Cl. CPC B05C 11/1042; B05C 11/1026; H01F 7/0252

(57) ABSTRACT

A fastening system for fastening an article to a heating hose, a corresponding heating hose and an application system having a corresponding fastening system. The fastening system is provided for a holder of the fastening system to be fastened magnetically to an end cap of the heating hose.

### FIELD OF THE INVENTION

The present invention relates to a fastening system for fastening an article to a heating hose. The invention also relates to a correspondingly designed heating hose and to an application system having a corresponding fastening system.

### BACKGROUND OF THE INVENTION AND RELATED ART

In a wide variety of industries, hot-melting flowable media, for example hot melt adhesives, are used to join parts to one another. Hot melt adhesives are used for example in the production of packaging, such as folding boxes or trays, in the graphical industry, the construction industry and wood industry, and for the production of mattresses. Such flowable media must generally be transferred from a solid state into a liquid state or pasty state by the action of heat before processing. The liquefied flowable medium is then supplied via a heatable heating hose to an application device, which is used for applying the flowable medium to a substrate. The heating hose is thus used as a heated and flexible transport path for the flowable medium. The application device can be, for example, a hand spray gun or an application head, in particular an application head provided with a dosing valve. The application device is generally heatable in order to keep the flowable medium at a temperature necessary for processing or within a certain temperature range.

To achieve a high degree of flexibility when installing adhesive application systems, it is desirable if the components of an application system, for example the heating hose, application device, control modules, sensors and cables, can be arranged variably and mounted simply. To achieve a high degree of flexibility when installing adhesive application systems, it is particularly desirable if, for example, the combination of application head, heating hose and application nozzle can be arranged flexibly. Under different installation conditions and space conditions and with differently oriented faces to be adhesively bonded, it should be possible to configure the application system optimally, as far as possible without different variants and without additional parts, and to adapt it to the product to be adhesively bonded. Fewer different variants of the application system mean a reduction in complexity and thus lower costs. It is also desirable for a simple and fast exchange of components of the application system to be possible.

Application heads, in particular spray heads, which are used to apply the flowable medium to a substrate should have the most compact and thus space-saving structure possible. The application heads can thereby be arranged close to the faces to which adhesive is to be applied. For adhesive bonding of good quality, it is disadvantageous when the nozzle from which the adhesive exits has to be arranged further away from the application point than a few millimetres. In particular with small packaging, large application heads must often be arranged further away from the adhesive bonding point than desired, owing to a lack of space. The accuracy of the adhesive application is thereby negatively affected, and the adhesive can cool down more than desired before the adhesive bonding. Adhesive spatter can occur, which causes soiling and is thus disruptive.

Against the background of the most optimal possible utilization of available installation space, it has proven advantageous when components of the application system, for example solenoid valves, control modules and similar, can be arranged as flexibly as possible relative to the actual application head. A disadvantage of this is that these further components must then be fastened separately, which is disadvantageous in the light of the most space-saving and simple assembly possible.

### OBJECT OF THE INVENTION

Therefore, the object of the present invention is to specify a fastening system which allows simple and space-saving fastening of components of an application system.

This object is achieved by a fastening system having the features thereof disclosed herein. This object is also achieved by a heating hose having the features thereof disclosed herein.

### SUMMARY OF THE INVENTION

The fastening system according to the present invention is used for fastening an article to a heating hose. Constituents of the fastening system are the heating hose per se, which is used for conducting a flowable medium, for example a hot melt adhesive, and a holder which is connected to the article to be fastened. The heating hose has an inlet end and an outlet end for the flowable medium, wherein the heating hose has an end cap, in particular in the form of a hose shell, at the outlet end and/or at the inlet end. The end cap is generally more dimensionally stable than the rest of the heating hose, and therefore the region of the heating hose covered with the end caps is less flexible. The end cap is generally used for end covering and thus protection of the internal flexible components of the heating hose, for example internal heating conductors, temperature sensors, thermal insulation material and electrical components. The end cap preferably also protects heating conductors, cables and connections between electrical lines, for example crimped connections. The end cap also often has a connection plug and/or a connection socket for electrically connecting electrical components or electronic components of the heating hose to an external control device and/or power supply. The connection plug and the connection socket can be connected or screw-fastened directly to the end cap or fastened to a connection cable which leads out between the end cap and the hose sheath of the heating hose. The connection plug is generally assigned to an apparatus for melting and/or pumping the flowable medium. The connection socket is generally assigned to the application head. It is provided for the heating hose to have, in the region of the end cap, a holding section for the holder. To hold the holder on the holding section, it is provided for the holder to have one or more permanently magnetic or ferromagnetic coupling elements and for the holding section to have one or more permanently magnetic or ferromagnetic mating coupling elements. The one or more permanently magnetic or ferromagnetic coupling elements and the one or more permanently magnetic or ferromagnetic mating coupling elements are arranged such that, when the holder is arranged on the holding section, the holder is held magnetically on the heating hose by means of the magnetic force between the one or more coupling elements and the one or more mating coupling elements, as a result of which the article connected to the holder is fastened to the heating hose.

This design has the advantage that an article provided with the holder can be connected to the heating hose particularly simply. By means of the magnetic force between the coupling elements and the mating coupling elements, the fastening can be made and undone particularly simply and even under restricted space conditions. The fastening can preferably take place without tools.

The end cap is generally formed close to a connection of the heating hose. When the heating hose is connected to a connection of an application device or melter or other components, a mechanical fastening of the heating hose is already realized close to the end cap, so that an additional fastening or support of the heating hose which may otherwise be necessary owing to the additional weight of the article fastened to the heating hose with the holder can be omitted.

In addition, the formation of the holding section in the region of the end cap has the advantage that the corresponding articles are arranged close to an application device connected to the hose end. This is advantageous in particular when the components are those which interact with the application device, for example a control device. Precisely in the case of a pneumatically operated application device, control devices such as solenoid valves should be positioned as close as possible to the application device to keep delay times as short as possible. The control devices can also be those which are used to operate solenoid valves electrically or to control electrically driven dosing valves.

The holder can in particular also be used to fasten open-loop or closed-loop control electronics for electrically operated valves of an application device to the heating hose.

The solenoid valve, control electronics and/or any further components of an application system can be attached to the holder or further holders, which are in turn fastened magnetically to holding sections of the heating hose. As a result, simple exchange and/or maintenance of these components is possible without it being necessary to remove the application device, for example in the form of an application head. The components to be provided in the application head can also be reduced to a necessary minimum needed for the functions of the application head. These are in particular a valve, a heating element and optionally a temperature probe. In contrast, components such as a solenoid valve, open-loop or closed-loop control electronics are designed as separate parts and therefore are not constituents of the application head. These separate parts can be fastened to the heating hose by means of the holder. This has an advantageous effect on the installation space requirement of the application head.

The holder can also be used to fasten one or more cables or lines in the region of the end cap of the heating hose and to act as a cable guide.

The holder can be an integral constituent of the article to be fastened or can be formed on the article. However, it is considered advantageous when the holder forms a separate part and in this respect acts as an adapter for fastening the article to the heating hose.

It is considered advantageous when the holding section has a latching contour, and the holder has a corresponding mating contour, wherein the latching contour and the mating contour can be brought into engagement. Preferably, the latching contour and the mating contour interact in the circumferential direction and/or the longitudinal direction of the heating hose so that the holder is prevented from shifting in the circumferential direction and/or the longitudinal direction. In contrast, the holder is held in the radial direction preferably exclusively by the magnetic force. By means of this design, sufficient fixing of the holder in all dimensions is achieved while still achieving particularly simple assembly and disassembly.

Preferably, the latching contour and the mating contour can be brought into engagement in different latching positions. A latching position appropriate for the use case can thereby be used. Preferably, the latching positions extend along the direction of the longitudinal extent of the heating hose.

Preferably, the holder has a baseplate consisting of a plastic, for example polyphenylene sulfide (PPS), the coupling elements being connected, preferably adhesively bonded, to the baseplate. The baseplate is preferably an injection-moulded part.

It is considered advantageous when the one or more coupling elements are permanently magnetic, and the one or more mating coupling elements are ferromagnetic.

The coupling elements are preferably disc magnets.

It is considered advantageous when the holder has at least two spaced coupling elements in the form of permanent magnets. Preferably, the permanent magnet(s) are mounted in a receptacle of the holder, the receptacle being open in the direction of the side to be turned towards the holding section so that the permanent magnet(s) are exposed on this side. A particularly strong magnetic force action is thereby achieved.

Preferably, the respective coupling element and the respective mating coupling element bear directly against one another.

The end cap is preferably less flexible, that is, more dimensionally stable, than the rest of the heating hose. Preferably, the end cap consists of a more rigid material than an outer sheath of the heating hose.

The heating hose according to the invention serves in particular for use in the fastening system according to the invention. The heating hose is used to conduct a flowable medium, in particular to supply flowable medium to an application device. In particular, the heating hose is used to conduct a hot melt adhesive, also referred to as hot glue. For such a heating hose, the term hot glue hose is also often used. The heating hose has an inlet end and an outlet end for the flowable medium, the heating hose being provided with an end cap at the outlet end and/or at the inlet end, the heating hose having a holding section for a holder in the region of the end cap, the holding section having one or more permanently magnetic or ferromagnetic mating coupling elements which are designed to interact magnetically with one or more permanently magnetic or ferromagnetic coupling elements of the holder in order to hold the holder on the holding section.

In a preferred embodiment, it is provided for the heating hose to have a flexible heating hose body, the heating hose body having a high-pressure hose with an internal inner tube and a reinforcement surrounding the inner tube. The high-pressure hose is enclosed circumferentially by a thermal insulation layer consisting of a thermal insulation material. Between the thermal insulation layer and the high-pressure hose there is at least one heating conductor for heating the medium flowing in the high-pressure hose. The flexible heating hose body also has an outer sheath, for example consisting of polyamide braiding, surrounding the thermal insulation layer. The end cap arranged at the end radially encloses the outside of the outer sheath and thus the heating hose body, the one or more mating coupling elements being arranged radially on the outside relative to the outer sheath. As a result, the one or more mating coupling elements are arranged particularly far outwards, which strengthens the magnetic force action with the holder and thus the holding force. In addition, this design has the advantage that during production of the heating hose the one or more mating coupling elements can be introduced shortly before or even after the end caps are mounted. As a result, the process of manufacturing the heating hose can take place largely independently and without taking into account the one or more mating coupling elements. As a result, largely automated manufacturing methods for the heating hose can be used or retained. The manufacturing process has to be adapted only with respect to the final assembly, specifically during the shaping and mounting of the end caps. As a result, existing manufacturing equipment can be retained.

Preferably, the one or more mating coupling elements are arranged between the end cap and the flexible outer sheath.

The end cap can be formed in one part. It is quite conceivable for the end cap to be injection-moulded or cast onto the heating hose.

In a particularly preferred embodiment, it is provided for the end cap to have two half-shells which together enclose the end of the heating hose.

Preferably, the two half-shells each form a portion of a receiving space for the respective mating coupling element. The portions can be for example in the form of an open pocket in the region of the contact faces of the half-shells. The assembly of the heating hose with regard to the introduction of the respective mating coupling element is thereby facilitated. During assembly, the mating coupling element can be laid or inserted into the portion of the receiving space of one of the half-shells. The mating coupling element is thereby already positioned in terms of its location. The second half-shell can then be connected, for example screw-fastened, to the first half-shell, whereby the mating coupling element is then fixed in position in the end cap. Separate joining methods such as adhesive bonding of the mating coupling elements and/or separate fastening elements such as screws can then be omitted.

In principle, it is also conceivable for the mating coupling element to be embedded in the material of the end cap, for example by overmolding the mating coupling element with the material of the end cap.

It is considered advantageous when the material of the end cap is temperature-resistant and impact-resistant. Preferably, the material is temperature-resistant up to a temperature of at least about 150° C., preferably at least about 200° C., particularly preferably at least about 250° C. Preferably, the end cap and/or the half-shells consist(s) of polyphenylene sulfide (PPS), in particular glass-fibre-reinforced PPS, or of glass-fibre reinforced liquid crystal polymer (LCP). However, other materials are also conceivable for the end cap and/or half-shells, in particular glass-fibre-reinforced temperature-resistant plastics. Preferably, the end cap and/or the half-shells are injection-moulded parts.

Preferably, the one or more mating coupling elements are each a strip of a ferromagnetic material. The metal strip preferably has a thickness of about 0.5 mm to about 2 mm.

The material of the one or more mating coupling elements is preferably magnetic stainless steel or a ferritic steel.

It is considered particularly advantageous when the end cap has multiple holding sections with one or more mating coupling elements, the holding sections being formed offset from one another in a circumferential direction and/or in a direction of the longitudinal extent of the heating hose. The holder and thus the article connected to the holder can thereby be attached particularly flexibly, specifically to different holding sections. In addition, multiple holders can also be attached to different holding sections.

Preferably, the holding sections are identical.

Preferably, the end cap has a first holding section and a second holding section which are formed radially opposite one another and offset from one another in the direction of longitudinal extent.

In an advantageous development, it is provided for the heating hose to have a connection piece having an internal through-duct for the flowable medium for coupling the heating hose to a consumer, for example an application device, or for coupling to a source of flowable medium, for example a melter, the connection piece having an end which is angled relative to a longitudinal extent of the heating hose. The angle is preferably between about 40° and about 50°, in particular about 45°. This design has the advantage that the heating hose leads out at different angles relative to the component, for example an application head, connected to the connection piece, depending on the rotary position of the connection piece. Different installation situations and outgoing directions can thereby be realized with the same heating hose.

The provision of multiple holding sections can be considered particularly advantageous precisely in connection with a heating hose having an angled connection piece, since the different outgoing directions and the space then available can be taken into consideration when the holder is arranged on the heating hose. For example, it is quite possible with a certain outgoing direction for one of the holding sections to be blocked by other components and as a result unusable or poorly accessible. Another holding section of the multiple holding sections can then be used.

In an advantageous embodiment, it is provided for the one or more mating coupling elements to be at least partially exposed radially to the outside. This can be achieved for example by means of corresponding through-openings in the end cap. The one or more coupling elements can thereby directly contact the one or more mating coupling elements, which has an advantageous effect on the magnetic holding force.

In an advantageous development, the holding section has a latching contour which extends in a direction of longitudinal extent of the heating hose. As a result, a mechanical fixing in the form of a form fit or a latching with a corresponding mating contour of the holder can be achieved in addition to the magnetic holding force. Preferably, the latching contour has latching structures which repeat in the direction of longitudinal extent. The holder can thus be latched at different positions in the direction of longitudinal extent.

The heating hose is in particular electrically heatable. Preferably, the heating hose is configured to keep the flowable medium at an operating temperature of about 20° C. to about 250° C. Preferably, the heating hose is pressure-stable up to an operating pressure of the flowable medium of at least about 100 bar, preferably at least about 300 bar. A hose length is preferably about 0.6 m to about 10 m. An inner tube of the hose used to conduct the flowable medium preferably has an inner diameter of about 2 mm to about 30 mm, in particular of about 6 mm to about 25 mm. The heating hose preferably has an outer diameter of about 20 mm to about 70 mm, in particular of about 27 mm to about 57 mm. The end cap preferably has a longitudinal extent of about 100 mm to about 300 mm.

The above statements relating to the advantages and features of the fastening system and the advantageous embodiments thereof apply, mutatis mutandis, to the heating hose, and vice versa.

The heating hose according to the invention and/or the fastening system according to the invention are preferably used in an application system for applying a flowable medium to a substrate. The application system has an application device, for example an application head, in particular a spray head. With a spray head, additional heated compressed air is preferably used to distribute the flowable medium onto a surface. The application system also comprises a heating hose and a holder according to the fastening system according to the invention or one of the embodiments thereof. The application device has a heating hose connection for the heating hose, for supplying the flowable medium to the application device. To this end, the heating hose can have a corresponding connection piece, which is connected to the heating hose connection of the application device. The application device has a pneumatically or electrically operated dosing valve in order to dispense the flowable medium supplied to the application device selectively from a dispensing opening of the application device. These tasks can be continuous or intermittent, for example to achieve an application in point, strip or bead form to the substrate. It is considered particularly advantageous when the application system has a preferably electrically operated solenoid valve for actuating the dosing valve, the solenoid valve having a compressed air connection for a compressed air supply and an output opening for the compressed air. The output opening is fluid-connected to the dosing valve via a hose, for example a pneumatic hose, so that the dosing valve can be actuated by switching the solenoid valve. The solenoid valve is connected to the holder, for example mechanically via a screw connection. The holder is in turn held magnetically on the holding section of the heating hose.

Depending on the switch position of the solenoid valve, compressed air can be conducted from the compressed air connection to the output opening, or the conduction of the compressed air from the compressed air connection to the output opening can be blocked, in order to actuate the dosing valve.

Because the solenoid valve forms a separate part from the application device, and the compressed air is conducted from the solenoid valve to the application device via a hose and thus via a flexible line, the solenoid valve can be handled and arranged largely independently of the application device. Only the hose length between the solenoid valve and the application head is fixed and cannot generally be changed without tools. The hose length of this hose thus limits the position of the solenoid valve in the direction of longitudinal extent of the heating hose when the solenoid valve is fastened to the heating hose by means of a holder. If a latching contour with multiple latching positions is provided, the latching position corresponding best to the individual compressed air hose length can be selected. Furthermore, the application device can be correspondingly smaller and more compact, as a result of which the space requirement of the application device per se is reduced, and also the available installation space can be utilized more flexibly, by a corresponding arrangement of the solenoid valve on the corresponding holding section of the heating hose. No additional external fastening means or retainers are necessary here. The holder with the solenoid valve only has to be arranged on the holding section and then holds on the basis of the magnetic force. As a result, complex assembly steps such as screw-fastenings are not necessary to attach the solenoid valve to the heating hose. As a result, the solenoid valve can be mounted on and removed from the heating hose even under restricted space conditions.

The components to be provided in the application head can be reduced to a necessary minimum needed for the functions of the application head, in particular a valve, a heating element, and optionally a temperature probe. This has an advantageous effect on the installation space requirement of the application head. The dosing valve can be integrated in the housing of the application head. In comparison with the usual structure, in which separate valve heads, so-called spray elements, are used, the structure is simplified further, and installation space can be saved as a result. The solenoid valve, control electronics and any further components can be attached to the holder or further holders, which are in turn fastened magnetically to holding sections of the heating hose. As a result, simple exchange and/or maintenance of these components is also possible without it being necessary to remove the application head.

A further advantage of the separate arrangement of the solenoid valve consists in that the application head per se has a lower mass, which has an advantageous effect on the mass to be heated of the application head. As a result, the energy requirement of the application head for heating the application head and the heating time are reduced. In addition, the application head can be thermally insulated better.

It is quite possible for an electronic module for controlling the solenoid valve to be connected to the solenoid valve. The electronic module can have a plug connection for a cable.

In a preferred embodiment, the dosing valve has a valve rod, the valve rod being displaceable between a closed position, in which the valve rod closes the dispensing opening of the application device, and an open position, in which the valve rod opens the dispensing opening of the application device, the dosing valve having a pneumatically operated actuator, the actuator having a piston, the piston being coupled to the valve rod to displace the valve rod from the closed position into the open position and/or from the open position into the closed position, the actuator being connected to the solenoid valve via the hose in order to apply compressed air to the piston of the actuator to displace the valve rod by means of the piston.

It is considered particularly advantageous when the application device has a heating hose connection, wherein a connection axis of the heating hose connection and a lifting axis of the valve rod are angled relative to one another, the heating hose having a connection piece which corresponds to the heating hose connection and has an internal through-duct for the flowable medium, the connection piece having an end which is angled relative to a longitudinal extent of the heating hose. This design has the advantage that the heating hose leads out from the application device at different angles depending on the rotary position of the connection piece. Different installation situations and outgoing directions can thereby be realized with the same heating hose without additional angled pieces having to be used.

In an advantageous development, to increase the flexibility further and to achieve further possible installation positions, the application head has a first dispensing opening and a second dispensing opening to dispense the flowable medium in two different directions, wherein the respective dispensing opening can be closed by means of a stopper in order to use only one of the two dispensing openings and to close the other dispensing opening with the stopper, depending on the desired dispensing direction. Two different dispensing directions can thereby be realized in a simple manner. Preferably, the dispensing direction of one of the two dispensing openings is parallel to the lifting axis of the valve rod.

In an advantageous embodiment, the dispensing openings are formed in a dispensing element which is mounted rotatably in the application head. The dispensing direction of at least one of the dispensing openings can thereby be rotated about the rotational axis of the dispensing element, as a result of which the dispensing direction can be changed flexibly.

Preferably, the angle between the connection axis of the heating hose connection and the lifting axis of the valve rod is between about 40° and about 50°, in particular about 45°. Preferably, the angle between the angled end of the connection piece and the longitudinal extent of the heating hose, when the heating hose is stretched, is between about 40° and about 50°, in particular about 45°.

Preferably, the heating hose is rotatable about the axis of the heating hose connection when connected to the heating hose connection. The outgoing direction of the heating hose can thereby be changed in a simple manner. It is considered particularly advantageous when the connection piece is only rotatable when the flowable medium is in the unpressurized state.

To keep the necessary installation space and assembly requirement of the application system low, it is considered advantageous when the dosing valve has a spring restoring means so that the dispensing opening is closed in an unpressurized state, wherein the solenoid valve is connected to the dosing valve only via a single hose. Because a spring restoring means is provided, an application of pressure to the dosing valve for the purpose of closing the dispensing opening can be omitted, so that the solenoid valve can have a particularly simple and thus compact design, and only a single hose connection is necessary between the solenoid valve and the application head.

### BRIEF DESCRIPTION OF THE DRAWING FIGURES

In the accompanying drawing figures, the present invention is explained in more detail by way of one or more exemplary embodiments without being limited thereto.

FIG. 1 shows an application system having an application head, a heating hose and a solenoid valve in a first configuration in a perspective view.

FIG. 2 shows the application system according to FIG. 1 in a side view.

FIG. 3 shows the heating hose in a perspective view.

FIG. 4 shows the heating hose in a view according to arrow IV in FIG. 3.

FIG. 5 shows the heating hose in a view according to arrow V in FIG. 3.

FIG. 6 shows the solenoid valve with a holder in a perspective view.

FIG. 7 shows the solenoid valve with the holder in a view from below.

FIG. 8 shows the application system according to FIG. 1 in a longitudinal section.

FIG. 9 shows a portion of FIG. 8.

FIG. 10 shows the application system according to FIG. 1 in a partially cut-away view.

FIG. 11 shows the application system in a sectional view according to line XI in FIG. 10.

FIG. 12 shows the application system in a sectional view according to line XII in FIG. 10.

FIG. 13 shows the heating hose in an internal view.

FIG. 14 shows the holder in a first perspective view.

FIG. 15 shows the holder in a second perspective view.

FIG. 16 shows the application system according to FIG. 1 in a second configuration in a side view.

### DETAILED DESCRIPTION OF EXEMPLARY EMBODIMENTS

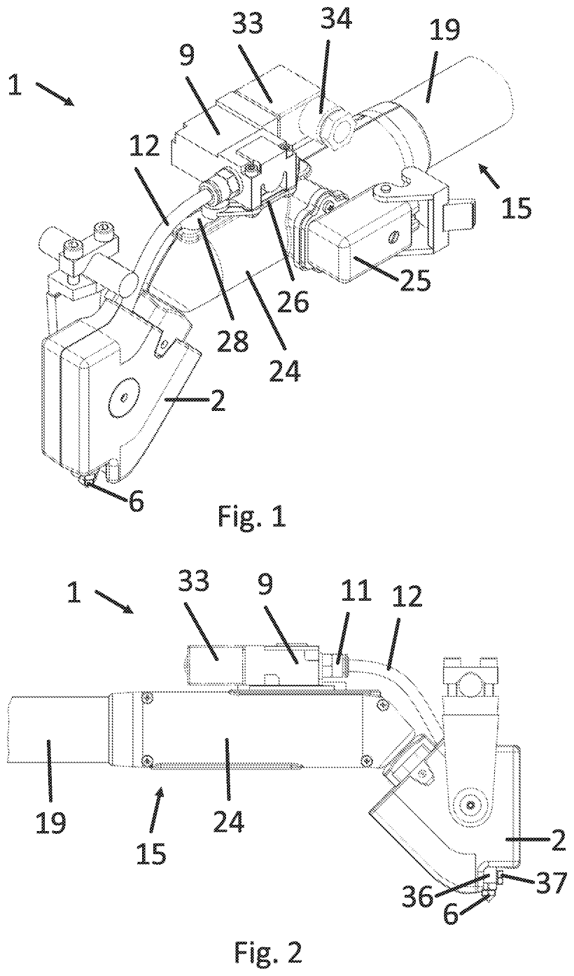

FIGS. 1 and 2 show an application system 1 for applying a hot melt adhesive which is flowable in a molten state. The application system 1 has a heatable application head 2 for applying the molten adhesive to a substrate. In the present case, the application head 2 is designed as a spray head and has a main body 3 (FIG. 9). In the main body 3, there is a heating element 4 (FIG. 9) in the form of a heating cartridge. The heating element 4 is used for the electrical heating of the application head 2 in order to keep the liquefied adhesive within the temperature range necessary for processing, for example about 150° C.-200° C. A dosing valve 5 (FIG. 9), which can be operated pneumatically, is also arranged in the main body 3. Via the dosing valve 5, a dispensing opening of the application head 2 is opened and closed. To this end, the dosing valve 5 has a valve rod 7 (FIG. 9), the valve rod 7 being displaceable between a closed position, in which the valve rod 7 closes the dispensing opening, and an open position, in which the valve rod 7 opens the dispensing opening, the dosing valve 5 having a pneumatically operated actuator, the actuator having a piston 8 (FIG. 9), the piston 8 being coupled to the valve rod 7 to displace the valve rod 7 from the closed position into the open position.

The application system 1 has a solenoid valve 9 to operate the actuator. The solenoid valve 9 has a compressed air connection 10 (FIG. 9) for connecting a compressed air supply and an outgoing connection 11 for compressed air. A pneumatic hose 12 is connected to the outgoing connection 11. The pneumatic hose 12 is in turn connected to a compressed air duct 13 (FIG. 9) which is formed in the main body 3 and opens into a pneumatic cylinder 14 (FIG. 9) having the piston 8. Depending on the switch position of the solenoid valve 9, compressed air is applied to the piston 8 in order to open the dosing valve 5. Closing the dosing valve 5 is effected by a spring restoring means.

The application system 1 further comprises a heating hose 15, the heating hose 15 being connected to the application head 2 via a connection piece 16 (FIG. 13) formed at an outlet end of the heating hose 15. The heating hose 15 has a flexible heating hose body. The heating hose body has a high-pressure hose 17 (FIG. 9), the high-pressure hose 17 having an internal flexible inner tube made of plastic for conducting the liquefied adhesive and a reinforcement, for example in the form of steel braiding, which surrounds the inner tube, in order to achieve the necessary pressure stability. Heating conductors are wound around the high-pressure hose 17, for example in the form of a heating band wound helically around the high-pressure hose 17. The heating conductors are not shown for reasons of clarity. The heating hose body also has a thermal insulation layer 18 (FIG. 9) consisting of a thermal insulation material, the heating conductors being formed between the thermal insulation layer 18 and the high-pressure hose 17. The heating hose body also has a flexible outer sheath 19 which consists of a woven polyamide fabric and surrounds the thermal insulation layer 18. The connection piece 16 has a through-duct 20 (FIG. 9) and has an angled design. One end 21 (FIG. 9) of the connection piece 16 is connected fluid-tightly to the inner tube via a screw connection 22 (FIG. 9) which is formed in the interior of the heating hose 15 and is therefore not accessible from the outside. Owing to the angled design of the connection piece 16, the other, free end 23 (FIG. 9) of the connection piece 16 is likewise angled, in the present case by about 45°, relative to the inner tube when the heating hose 15 is stretched, as can be seen in particular in FIG. 13, wherein the thermal insulation layer 18, the heating conductors and the outer sheath 19 are not shown in FIG. 13 for reasons of clarity.

At the outlet end, the heating hose 15 has a dimensionally stable, radially outwardly arranged end cap 24 which consists of polyphenylene sulfide (PPS), that encloses the heating hose body in the circumferential direction and covers it at the end. The electrical connection lines of the heating hose body, for example the heating conductors, which are exposed at the end, lead outwards through the end cap 24 and are wired to a connection socket 25 attached to the end cap 24.

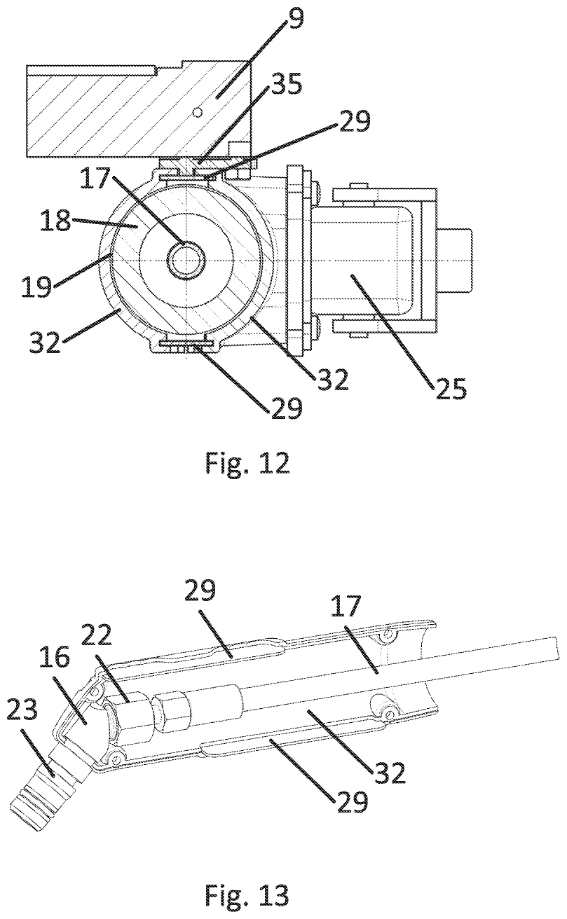

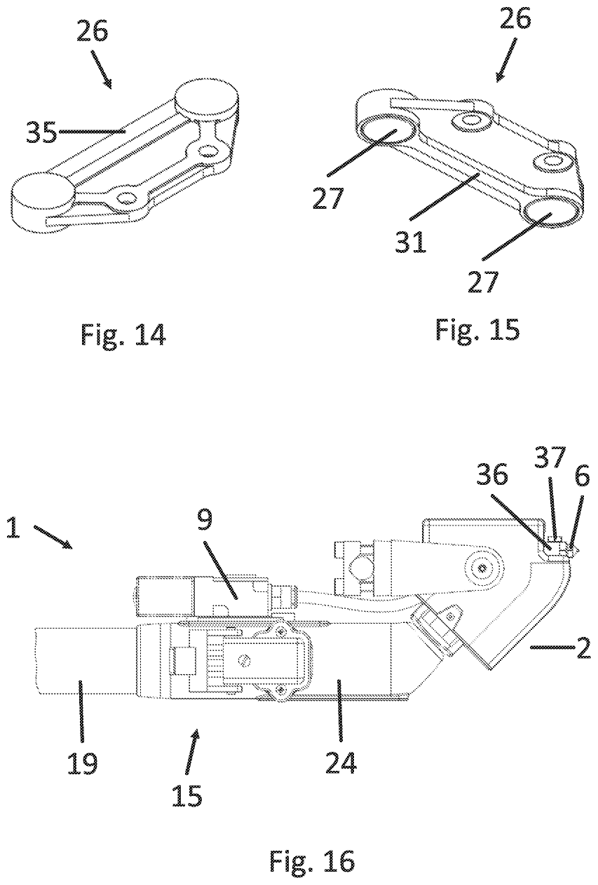

The solenoid valve 9 is magnetically fastened to the end cap 24. For this purpose, the solenoid valve 9 is screw-fastened to a holder 26. The holder 26 as such is shown separately in FIGS. 14 and 15. The holder 26 has a baseplate 35 consisting of plastic, in particular of polyphenylene sulfide (PPS), wherein two permanently magnetic coupling elements 27 in the form of cylindrical permanent magnets are arranged in the baseplate 35 on its underside to be turned towards holding sections 28, 28′. The solenoid valve 9 is arranged on the upper side opposite the underside and is screw-fastened to the baseplate 35. The end cap 24 has two holding sections 28, 28′ which are opposite one another and offset from one another in the longitudinal direction of the heating hose 15. The respective holding section 28, 28′ has a ferromagnetic mating coupling element 29 (FIGS. 9-13) in the form of a metal strip so that, when the holder 26 is arranged on one of the holding sections 28, 28′, the holder 26 is held magnetically on this holding section 28, 28′ and thus on the heating hose 15 by the magnetic force between the permanent magnets and the metal strip, as a result of which the solenoid valve 9 connected to the holder 26 is fastened to the heating hose 15.

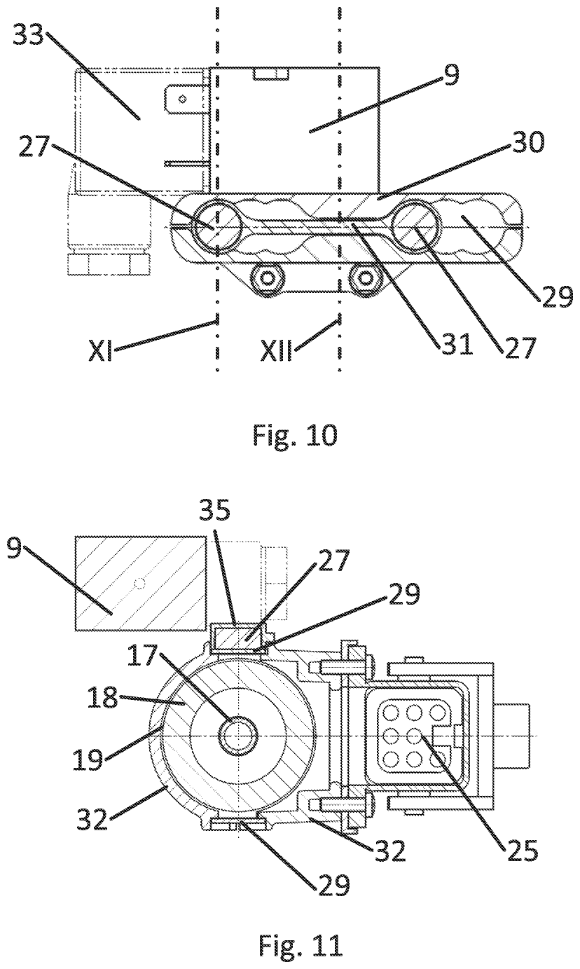

In addition, the respective holding section 28, 28′ has a latching contour 30 (FIG. 10), and the holder 26 has a corresponding mating contour 31 (e.g., FIG. 10). The latching contour 30 is in each case formed by recesses in the end cap 24. The latching contour 30 has two groups of three circular recesses merging into one another and a groove extending between these groups. The baseplate 35 of the holder 26 has, on its underside to be turned towards the holding section 28, 28′, two circular ring-shaped projections and a ridge connecting the projections. The outer diameter of the circular ring-shaped projections corresponds to the inner diameter of the circular recesses. The projections are arranged such that, in the respective latching position, one projection is in engagement with a recess of the first group, and the other projection is in engagement with a recess of the second group. Accordingly, the contours 30, 31 can be brought into engagement with one another in three different latching positions, as can be seen in particular in FIG. 10. The ridge comes into engagement with the groove in the respective latching position. Stable fixing of the holder 26 in the holding section 28, 28′ in the direction of longitudinal extent and the circumferential direction of the heating hose 15 is thereby achieved. The coupling elements 27 are received in the respective projection and adhesively bonded to the baseplate 35.

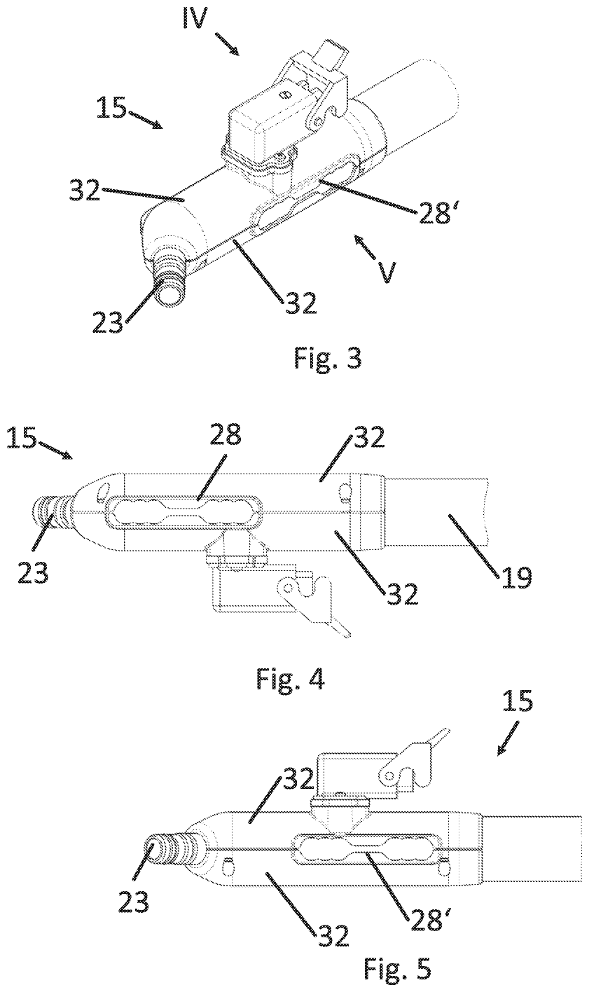

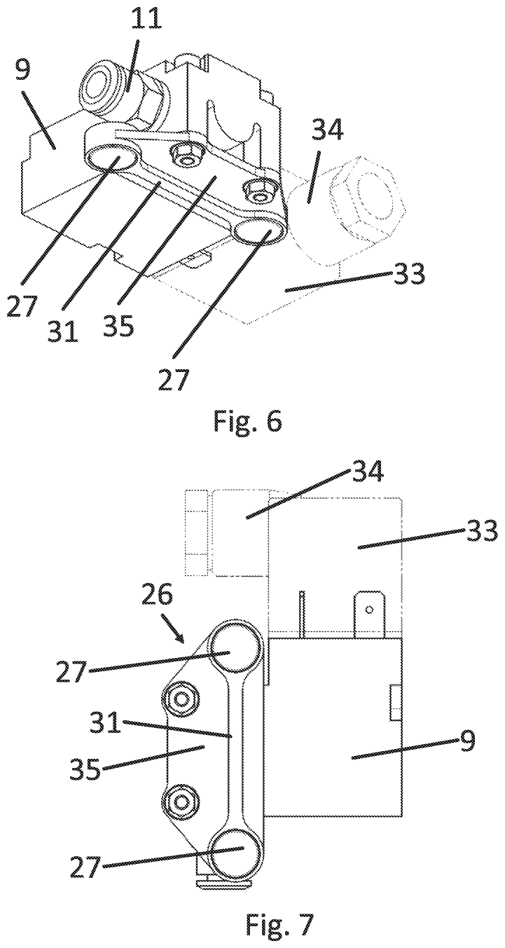

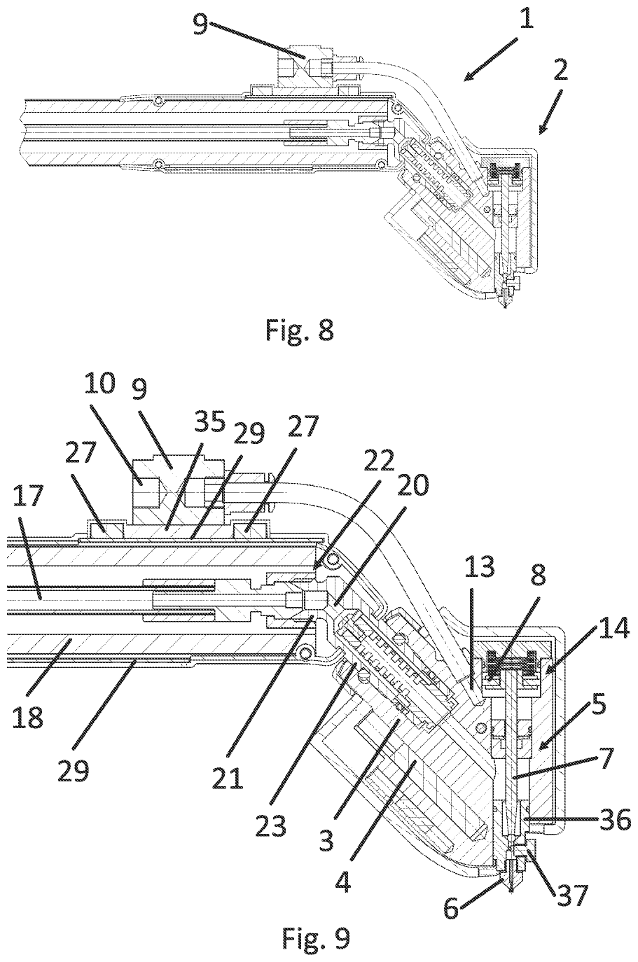

In the present case, the end cap 24 is formed by two half-shells 32 (e.g., FIGS. 3-5) which are screw-fastened to one another. The two half-shells 32 each form a portion of a receiving space for the respective mating coupling element 29 (e.g., FIG. 9). The respective half-shell 32 engages radially inwards and radially outwards behind the respective mating coupling element 29 in the edge region of the mating coupling element 29. The respective mating coupling element 29 is arranged such that it is spaced from the hose sheath 19.

The coupling elements 27 and the mating coupling elements 29 are each exposed on their mutually facing sides so that the coupling elements 27 bear directly against the mating coupling elements 29 when the holder 26 is arranged on one of the holding sections 28, 28′.

It is quite possible for an electronic module 33 for controlling the electrically operated solenoid valve 9 to be attached to the solenoid valve 9. The electronic module 33 has a connection socket 34 for a cable. The electronic module 33 can also act simply as an adapter for connecting a cable to the solenoid valve 9.

Thanks to the two holding sections 28, 28′, the solenoid valve 9 can be connected to the heating hose 15 in different regions so that two basic configurations or arrangements of the solenoid valve 9 on the heating hose 15 are possible. FIG. 1 shows a first configuration in which the solenoid valve 9 is attached to the first holding section 28. FIG. 16 shows a second configuration in which the solenoid valve 9 is attached to the second holding section 28′. In the second configuration, the heating hose 15 is also arranged on the application head 2 rotated by about 180° in comparison with the first configuration.

To increase the flexibility further and to achieve further possible installation positions, the application head 2 has a dispensing element 36 with a branching dispensing duct, the branches of which each open into a dispensing opening, the dispensing directions of which are formed perpendicularly to one another. In the closed position, the valve rod 7 closes the through-duct 20 on the inside so that in the closed position the dispensing openings are closed on the inside. Only one of the two dispensing openings is used during operation, with an application nozzle 6 being screwed into this dispensing opening, while a closure stopper 37 is screwed into the other dispensing opening. The dispensing direction of the adhesive from the application head 2 can be changed simply by exchanging the closure stopper 37 and the application nozzle 6.

The dispensing element 36 is mounted in the application head 2 rotatably about the lifting axis of the valve rod 7, as a result of which the dispensing opening which is closed in the present exemplary embodiment can be rotated about the lifting axis to change the dispensing direction thereof.

That which is claimed is:

1-15. (canceled)

16. A fastening system for fastening an article to a heating hose, wherein the fastening system has a heating hose for conducting a flowable medium and a holder connected to the article to be fastened, wherein the heating hose has an inlet end and an outlet end for the flowable medium, wherein the heating hose has an end cap at the outlet end and/or at the inlet end, wherein the heating hose has a holding section for the holder in the region of the end cap, wherein the holder has one or more permanently magnetic or ferromagnetic coupling elements, wherein the holding section has one or more permanently magnetic or ferromagnetic mating coupling elements, wherein the one or more permanently magnetic or ferromagnetic coupling elements and the one or more permanently magnetic or ferromagnetic mating coupling elements are arranged such that, when the holder is arranged on the holding section, the holder is held magnetically on the heating hose by means of the magnetic force between the one or more permanently magnetic or ferromagnetic coupling elements and the one or more permanently magnetic or ferromagnetic mating coupling elements, as a result of which the article connected to the holder is fastened to the heating hose.

17. The fastening system according to claim 16, wherein the holding section has a latching contour, and the holder has a corresponding mating contour, wherein the latching contour and the mating contour can be brought into engagement in different latching positions.

18. The fastening system according to claim 16, wherein the one or more permanently magnetic or ferromagnetic coupling elements are permanently magnetic, and the one or more permanently magnetic or ferromagnetic mating coupling elements are ferromagnetic.

19. A heating hose for conducting a flowable medium, wherein the heating hose has an inlet end and an outlet end for the flowable medium, wherein the heating hose has an end cap at the outlet end and/or at the inlet end, wherein the heating hose has a holding section for engaging with a holder in the region of the end cap, wherein the holding section has one or more permanently magnetic or ferromagnetic mating coupling elements configured for engaging magnetically with one or more permanently magnetic or ferromagnetic coupling elements of the holder to hold the holder on the holding section.

20. The heating hose according to claim 19, wherein the heating hose has a flexible heating hose body, wherein the heating hose body has a high-pressure hose with an internal inner tube and a reinforcement surrounding the inner tube, a thermal insulation layer which surrounds the high-pressure hose and consists of a thermal insulation material, at least one heating conductor formed between the high-pressure hose and the thermal insulation layer, and an outer sheath surrounding the thermal insulation layer, wherein the end cap radially encloses the outer sheath, wherein the one or more permanently magnetic or ferromagnetic mating coupling elements are arranged radially on the outer sheath.

21. The heating hose according to claim 20, wherein the one or more permanently magnetic or ferromagnetic mating coupling elements are arranged between the end cap and the outer sheath.

22. The heating hose according to claim 19, wherein the end cap has two half-shells, wherein the two half-shells each form a portion of a receiving space for the respective one or more permanently magnetic or ferromagnetic mating coupling element.

23. The heating hose according to claim 19, wherein the one or more permanently magnetic or ferromagnetic mating coupling elements are each a strip of a ferromagnetic material.

24. The heating hose according to claim 19, wherein the end cap has more than one holding sections each with one or more permanently magnetic or ferromagnetic mating coupling elements, wherein the holding sections are offset from one another in a circumferential direction and/or in a direction of the longitudinal extent of the heating hose.

25. The heating hose according to claim 19, wherein the heating hose has a connection piece having an internal through-duct for the flowable medium for coupling the heating hose to a consumer or to a source of the flowable medium, wherein the connection piece has an end which is angled relative to a longitudinal extent of the heating hose.

26. The heating hose according to claim 19, wherein the one or more permanently magnetic or ferromagnetic mating coupling elements are at least partially exposed radially to the outside.

27. The heating hose according to claim 19, wherein the holding section has a latching contour which extends in a direction of longitudinal extent of the heating hose and has latching structures which repeat in the direction of longitudinal extent of the heating hose.

28. An application system for applying a flowable medium to a substrate, wherein the application system has an application device and the heating hose and the holder according to the fastening system of claim 16, wherein the application device has a connection for the heating hose for supplying the flowable medium to the application device and a pneumatically operated dosing valve to dispense the flowable medium supplied to the application device selectively from a dispensing opening of the application device, wherein the application system has a solenoid valve for operating the dosing valve, wherein the solenoid valve has a compressed air connection for a compressed air supply, wherein the solenoid valve has an output opening for the compressed air, wherein the output opening is fluid-connected to the dosing valve via a hose, wherein the solenoid valve has the holder or is connected to the holder, and wherein the holder is held magnetically on the holding section of the heating hose.

29. The application system according to claim 28, wherein the dosing valve has a valve rod, wherein the valve rod is displaceable between a closed position, in which the valve rod closes the dispensing opening of the application device, and an open position, in which the valve rod opens the dispensing opening of the application device, wherein the dosing valve has a pneumatically operated actuator, wherein the actuator has a piston, wherein the piston is coupled to the valve rod to displace the valve rod from the closed position into the open position and/or from the open position into the closed position, wherein the actuator is connected to the solenoid valve via the hose to apply compressed air to the piston of the actuator to displace the valve rod by means of the piston.

30. The application system according to claim 28, wherein the dosing valve has a spring restoring means so that the dispensing opening is closed in an unpressurized state, and wherein the solenoid valve is connected to the dosing valve via a single one of the hose.
